(19) United States
(12) Patent Application Publication
(10) Pub. No.: US 2026/0135394 A1
(43) Pub. Date: May 14, 2026

(54) METHOD AND SYSTEM FOR ELECTRICALLY POWERED OFF-GRID SITE CLEARANCE

(71) Applicant: Air Burners, Inc., Palm City, FL (US)

(72) Inventor: Brian M. O'CONNOR, Palm City, FL (US)

(21) Appl. No.: 19/374,246

(22) Filed: Oct. 30, 2025

Related U.S. Application Data
(60) Provisional application No. 63/720,459, filed on Nov. 14, 2024.

(51) Int. Cl. H02J 7/14; F23G 5/40; H01M 10/44; H01M 10/46

(52) U.S. Cl. CPC H02J 7/14; F23G 5/40; H01M 10/44; H01M 10/46; F23G 2203/601; F23G 2206/203; F23G 2209/26; H01M 2220/10

(57) ABSTRACT

A method for clearing a site of vegetative waste includes deploying a portable power generation system and a burner unit to the site. The power generation system has a first air curtain firebox for burning vegetative waste and is configured to generate electrical power from heat energy released by burning vegetative waste in the first air curtain firebox and store the electrical power in a battery pack. The burner unit has a second air curtain firebox for burning vegetative waste and a battery for supplying electrical power to its electrical components. The method further includes burning vegetative waste from the site in the first air curtain firebox to generate and store electrical power in the battery pack, burning vegetative waste from the site in the second air curtain firebox, transporting the battery pack to the burner unit or vice versa, and recharging the burner unit battery using the battery pack.

### CROSS-REFERENCE TO RELATED APPLICATION

The present application claims priority to and benefit of U.S. Provisional Patent Application No. 63/720,459 filed Nov. 14, 2024, the entire disclosure of which is incorporated herein by reference.

### FIELD OF THE DISCLOSURE

The present disclosure relates to methods and systems for clearing a site of vegetative waste, including sites located remotely from a power grid, without reliance on fossil fuels such as diesel fuel.

### BACKGROUND OF THE DISCLOSURE

It is known to clear a site of biomass such as vegetative waste by collecting the vegetative waste and burning it in a firebox, for example an air curtain firebox that minimizes release of particulates during burning. One application of this environmentally friendly technology that is growing in importance is wildfire prevention. The firebox may be a transportable module mounted on a skid base for over the road and off-road trailer transport to a job site remote from the established public power grid, for example a site within a forest and/or in rough terrain. It is also known to provide a portable power generating module locatable adjacent the firebox module that captures and uses hot exhaust from the firebox to generate and store electrical power, as taught by U.S. Pat. No. 9,644,501.

The present applicant markets trailer-mounted air curtain burner units under the trademarks CHARBOSS® and BURNBOSS®, and a self-propelled air curtain burner unit under the trademark TRACKBOSS®. The CHARBOSS unit includes a firebox equipped with an air curtain manifold connected to an air fan, a conveyor underneath the firebox for conveying pieces of biochar to a discharge region at the rear of the trailer for quenching, and hydraulic actuators for raising and lowering the firebox and agitating the firebox to dispense pieces of biochar from the firebox onto the conveyor. The BURNBOSS unit is similar to the CHARBOSS unit, but is not configured for harvesting biochar and therefore lacks a conveyor system beneath its firebox. The TRACKBOSS unit is similar to the BURNBOSS unit, except that it is track-driven by remote control to avoid the need for trailer transport at a job site. The current commercial embodiments use a diesel fueled engine to power the air curtain fan and a hydraulic pump that drives the hydraulic actuators. The current commercial embodiments also include a battery for powering electrical control circuits, trailer lights, trailer brakes, and other electrical components of the unit. These commercial embodiments rely on diesel fuel and cannot be operated solely by electrical power. Consequently, it is impossible to keep the current CHARBOSS unit, BURNBOSS unit, or TRACKBOSS unit running only by supplying it with electrical power generated by a power generating module described in the previous paragraph. Diesel fuel must be transported through difficult terrain to a remote site, or the burner unit must be towed out of the remote site, for refueling. This is time consuming, costly, and involves the burning of fossil fuels to the detriment of the environment.

### SUMMARY OF THE DISCLOSURE

The present disclosure provides a method and system for clearing a site of vegetative waste, including sites located remotely from a power grid, without reliance on fossil fuels such as diesel fuel.

A site-clearing method according to an embodiment of the present disclosure generally comprises deploying a portable power generation system and a burner unit to the site. The deployed power generation system includes a firebox module having a first air curtain firebox for burning vegetative waste, wherein the power generation system is configured to generate electrical power from heat energy released by burning vegetative waste in the first air curtain firebox and store the electrical power in a battery pack. The deployed burner unit includes a second air curtain firebox for burning vegetative waste and a battery for supplying electrical power to electrical components of the burner unit.

The site-clearing method further comprises burning vegetative waste from the site in the first air curtain firebox to generate and store electrical power in the battery pack, and burning vegetative waste from the site in the second air curtain firebox. The site-clearing method additionally comprises transporting the battery pack to the burner unit or transporting the burner unit to the battery pack, and recharging the battery of the burner unit using electrical power stored in the battery pack.

A system according to an embodiment of the present disclosure that is useful for carrying out the site-clearing method generally comprises a power generation system and a burner unit. The power generation system includes a firebox module and a battery pack. The firebox module has a first air curtain firebox for burning vegetative waste. The power generation system is configured to generate electrical power from heat energy released by burning vegetative waste in the first air curtain firebox and store the electrical power in the battery pack.

The burner unit includes a second air curtain firebox for burning vegetative waste and a battery for supplying electrical power to electrical components of the burner unit. The battery of the burner unit is rechargeable using electrical power stored in the battery pack.

### BRIEF DESCRIPTION OF THE DRAWING VIEWS

The nature and mode of operation of the present disclosure will now be more fully described in the following detailed description taken with the accompanying drawing figures, in which:

FIG. 1 is a generally front perspective view of a trailer burner unit according to an embodiment of the present disclosure;

FIG. 2 is a generally rear perspective view of the trailer unit shown in FIG. 1;

FIG. 3 is a perspective view of a power generation system and electric vehicle according to an embodiment of the present disclosure;

FIG. 4 is a schematic block diagram of the trailer unit shown in FIGS. 1 and 2;

FIG. 5 is a schematic block diagram of the power generation system and electric vehicle shown in FIG. 3 in conjunction with the trailer unit of FIGS. 1, 2 and 4; and

FIG. 6 is a flow diagram illustrating a method for electrically powered off-grid site clearance according to an embodiment of the present disclosure.

### DETAILED DESCRIPTION

In accordance with the present disclosure, a method and system for electrically powered off-grid site clearance is provided. In an embodiment of the disclosure, applicant's CHARBOSS, BURNBOSS, or TRACKBOSS burner unit is modified to operate solely by electrical power supplied by a battery in the burner unit, such that the burner unit battery may be recharged at a remote off-grid job site with the help of a power generation system also located at the job site.

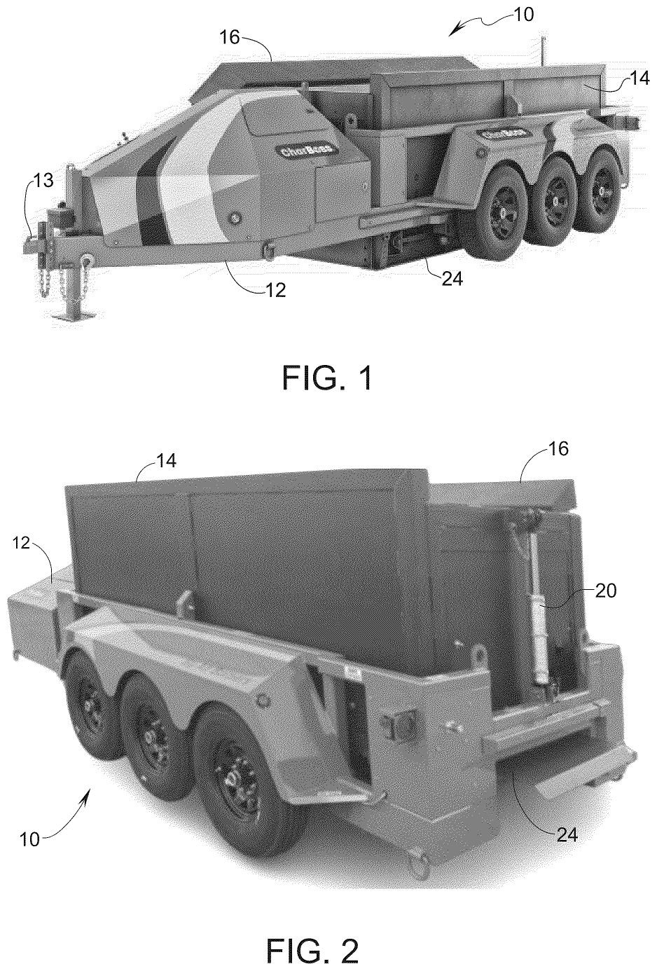

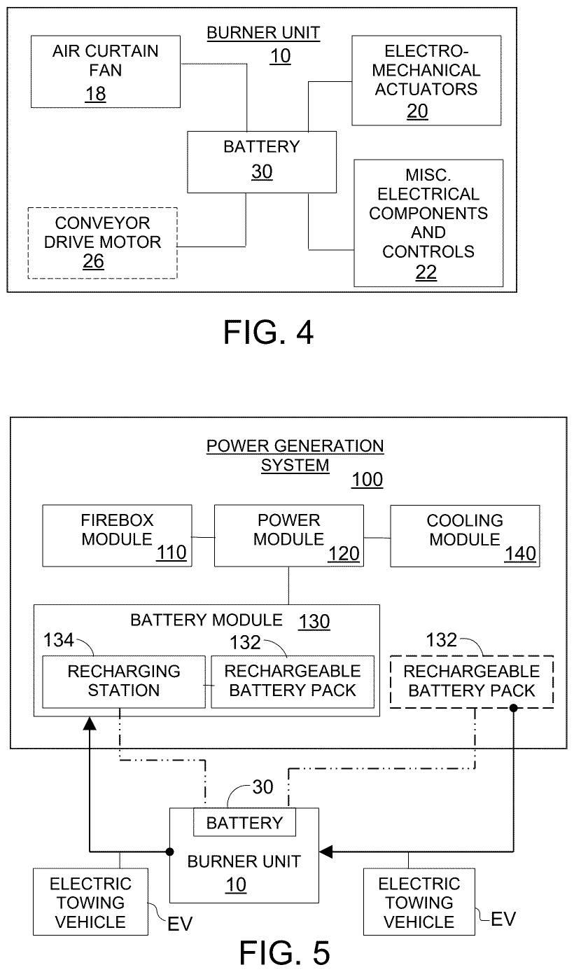

FIGS. 1 and 2 show an air curtain burner unit 10 according to an embodiment of the present disclosure. FIG. 4 is a schematic block diagram of the burner unit 10 showing relevant components thereof. Burner unit 10 may include a multi-axle wheeled trailer 12 and a towing hitch 13 at a front end of trailer 12. In another variant, burner unit 10 may include a pair of ground-engaging tracks operated by remote control to propel the burner unit. Burner unit 10 further includes a firebox 14 carried by trailer 12, an air curtain manifold 16 arranged along a top longitudinal edge of firebox 14, an electrically powered air curtain fan 18 for supplying a flow of air to air curtain manifold 16, one or more electromechanical actuators 20 (only one being visible in FIG. 2) arranged and operable to move firebox 14 relative to trailer 12, and miscellaneous electrically powered components 22 such as lights, brakes, and system controllers. Burner unit 10 may also include an endless biochar conveyor 24 beneath firebox 14 and an electric conveyor drive motor 26 for driving conveyor 24.

As shown in FIG. 4, burner unit 10 includes a rechargeable battery 30 connected to supply electrical power to air curtain fan 18, electromechanical actuators 20, electrically powered components 22, and optional conveyor drive motor 26. Battery 30 may be of a type used for powering electric vehicles, such as a battery supplied by Volvo Penta.

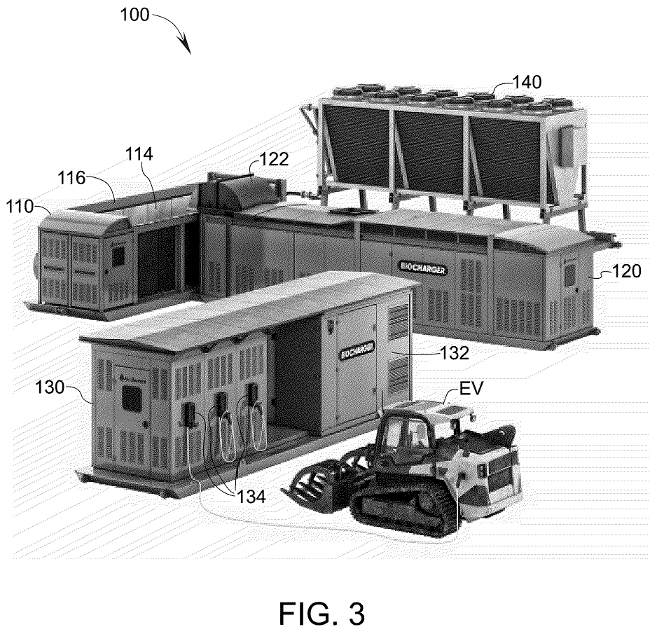

FIGS. 3 and 5 illustrate a power generation system 100 and an electric vehicle EV according to an embodiment of the present disclosure. Power generation system 100 may include a firebox module 110, a power module 120, a battery module 130, and a cooling module 140. Modules 110, 120, 130, and 140 are portable and each may include an integral transport skid at its base that is suitable for transporting the module by truck to a job site where vegetation is to be cleared. Firebox module 110 may include a firebox 114 in which vegetative waste is burned and an air curtain system 116 for containing particulates within the firebox during burning. Power module 120 is locatable adjacent firebox module 110 and may include a hood 122 for capturing hot exhaust from firebox module 110 during burning. Power module 120 uses the hot exhaust from firebox module 110 to generate electrical power. For example, as taught by U.S. Pat. No. 9,644,501, captured exhaust heat may drive an organic Rankine cycle (“ORC”) of power module 120 to generate electrical power. Such an ORC unit circulates a coolant such as cold water pumped from cooling module 140, a local water source, cooling tower, or other device to a condenser of power module 120 for condensing a working fluid of the ORC unit. The generated electrical power is stored in a rechargeable battery pack 132 that may be incorporated into battery module 130. Alternatively, battery pack 132 may be incorporated into power module 120. Battery pack 132 may be a commercially available towable battery pack system. By way of non-limiting example, a 550 kWh MTU Energy Pack QS by Rolls Royce is found to be suitable for practicing the present disclosure. Battery module 130 may also include one or more EV charging stations 134 connected to battery pack 132 each having an EV charger on an EV charging cable. Electronics may be housed within an interior space of battery module 130 for receiving and conditioning power stored by battery pack 132 for a variety of purposes. The conditioning electronics may include a transformer connected to receive power from battery pack 132 and convert the power to AC power suitable for EV charging stations 134. For example, EV charging stations may include Level 2 EV chargers for efficiently recharging electric vehicle batteries such as burner unit battery 30 at the job site. Power generation system 100 may be a BIOCHARGER® power generation system available from applicant Air Burners, Inc. of Palm City, Florida.

In a first implementation of the present disclosure, battery pack 132 may be decoupled from battery module 130 and towed by an EV to burner unit 10, which may be at a peripheral location on the job site remote from power generation system 100. In a variant of the first implementation described above, a towable second battery pack 132 may be provided that is independent from and rechargeable by the battery pack 132 associated with battery module 130 or is directly rechargeable by power module 120, and the second battery pack may be towed by an EV to burner unit 10. In another variant of the first implementation described above, battery module 130 including battery pack 132 may be towed by an EV to burner unit 10. Once battery pack 132 is transported to burner unit 10, the battery pack may be connected to burner unit battery 30 to recharge the burner unit battery at the location of burner unit 10.

In a second implementation of the present disclosure, burner unit 10 may be towed by an EV or self-propelled from its peripheral location on the job site to the location of power generation system 100, and more specifically to a location near battery module 130. Once burner unit 10 is positioned near battery module 130, its battery 30 may be recharged by battery pack 132 of battery module 130, for example using a charging station 134 of the battery module.

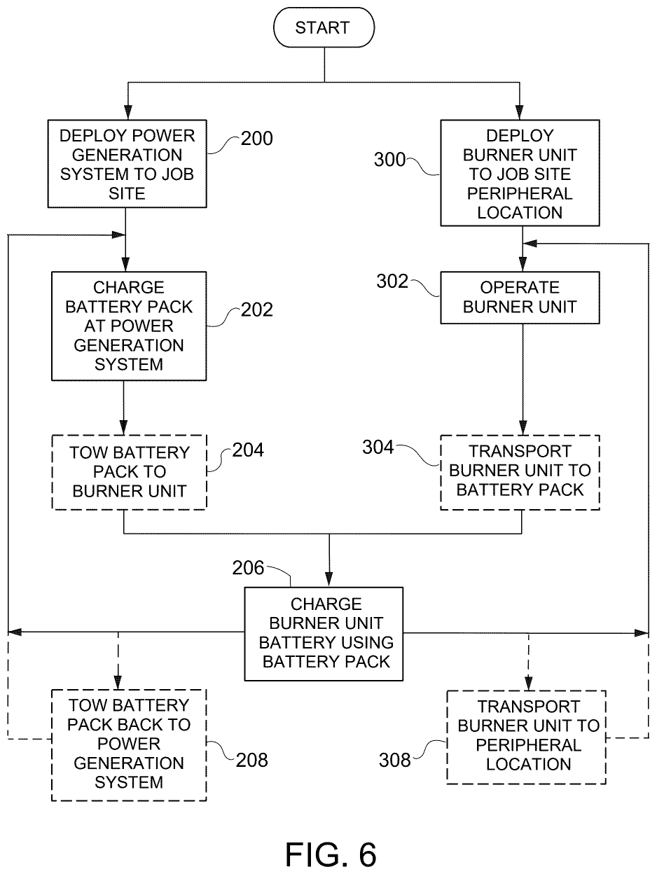

FIG. 6 illustrates a method for electrically powered off-grid site clearance according to an embodiment of the present disclosure. The method includes deploying power generation system 100 to a job site according to step 200 and deploying burner unit 10 to a peripheral location at the job site, i.e., a location at the job site distanced from the location of power generation system 100, according to step 300. The method further includes charging battery pack 132 at power generation system 100 according to step 202. As may be understood, this step involves clearing vegetative waste from the job site and burning the vegetative waste in firebox module 110, thereby providing heat energy to power module 120 that the power module converts to electrical power stored in battery pack 132. The method further includes operating burner unit 10 according to step 302 to clear vegetative waste from the job site. If burner unit 10 is configured for biochar production, then this step has the added benefit of producing useful biochar.

The next step in the method depends on whether the first implementation or the second implementation described above is followed. If the first implementation is followed, then battery pack 132 is towed by an EV to burner unit 10 as indicated by step 204. If the second implementation is followed, then burner unit 10 is towed by an EV or self-propelled to battery pack 132 at the location of power generation system 100 as indicated by step 304. Broken lines are used for blocks 204 and 304 to indicate that these steps are optional alternatives of one another depending upon the implementation followed.

Next, burner unit battery 30 is charged using power stored in battery pack 132 according to step 206 to enable continued operation of burner unit 10.

If the first implementation was followed, then battery pack 132 may be towed by EV back to power generation system 100 according to step 208 and reconnected with the power generation system. If the second implementation was followed, then burner unit 10 may be towed by EV or self-propelled to a peripheral location on the job site according to step 308. The peripheral location may be the same as or different from the previous peripheral location of burner unit 10.

After step 206 and either step 208 or 308, flow reverts to steps 202 and 302, and more vegetative waste is cleared and burned in firebox module 110 and burner unit 10. The method may continue in a green, self-sustaining manner until the job site is sufficiently cleared.

As will be appreciated, the electrical power that is generated and stored in battery pack 132 may be used to recharge battery-powered equipment and machinery other than an EV or the battery 30 of burner unit 10. For example, the stored power may be used to recharge battery-powered chainsaws and other tools used to collect vegetative waste at the job site.

While the disclosure sets forth exemplary embodiments, the detailed description is not intended to limit the scope of the disclosure to the particular forms set forth. The disclosure is intended to cover such alternatives, modifications and equivalents of the described embodiments as may be included within the scope of the claims.

What is claimed is:

1. A method for clearing a site of vegetative waste, the method comprising:
deploying a portable power generation system to the site, wherein the power generation system includes a firebox module having a first air curtain firebox for burning vegetative waste, wherein the power generation system is configured to generate electrical power from heat energy released by burning vegetative waste in the first air curtain firebox and store the electrical power in a battery pack;
deploying a burner unit to the site, wherein the burner unit includes a second air curtain firebox for burning vegetative waste and a battery for supplying electrical power to electrical components of the burner unit;
burning vegetative waste from the site in the first air curtain firebox to generate and store electrical power in the battery pack;
burning vegetative waste from the site in the second air curtain firebox;
transporting the battery pack to the burner unit or transporting the burner unit to the battery pack; and
recharging the battery of the burner unit using electrical power stored in the battery pack.

2. The method according to claim 1, wherein the battery pack is transported to the burner unit in preparation for the recharging step.

3. The method according to claim 1, wherein the burner unit is transported to the battery pack in preparation for the recharging step.

4. A system for clearing vegetative waste from a site, the system comprising:
a power generation system including a firebox module and a battery pack, the firebox module having a first air curtain firebox for burning vegetative waste, wherein the power generation system is configured to generate electrical power from heat energy released by burning vegetative waste in the first air curtain firebox and store the electrical power in the battery pack; and
a burner unit including a second air curtain firebox for burning vegetative waste and a battery for supplying electrical power to electrical components of the burner unit;
wherein the battery of the burner unit is rechargeable using electrical power stored in the battery pack.

5. The system according to claim 4, wherein the battery pack is removable from the power generation system and transportable to the burner unit for recharging the battery of the burner unit.

6. The system according to claim 4, wherein the burner unit is a self-propelled burner unit, whereby the burner unit is drivable to the battery pack of the power generation system for recharging the battery of the burner unit.
